(19) United States
(12) Patent Application Publication
(10) Pub. No.: US 2017/0248451 A1
(43) Pub. Date: Aug. 31, 2017

(54) DEVICE AND METHOD FOR MOUNTING AND ORIENTING A SENSOR ON A SUPPORT

(71) Applicant: 01DB-METRAVIB, Limonest (FR)

(72) Inventors: Franck GINET, Massieux (FR); Pascal VOUAGNER, Fleurieu Sur Saone (FR); Thierry MAZOYER, Auzelles (FR)

(73) Assignee: 01DB-METRAVIB, Limonest (FR)

(21) Appl. No.: 15/521,642

(22) PCT Filed: Oct. 29, 2015
(86) PCT No.: PCT/FR2015/052924

§ 371 Date: Apr. 25, 2017

(30) Foreign Application Priority Data
Oct. 31, 2014 (FR) 14 60491

(51) Int. Cl. G01D 11/30; F16B 5/02

(52) U.S. Cl. CPC G01D 11/30; F16B 5/0275

(57) ABSTRACT

A device for assembling together at a determined orientation a sensor (3) with a thread (6) and a support (2) having a tapped hole (12), the device including a first threaded portion (9) adapted to co-operate with the thread (6) of the sensor and a second threaded portion (11), of pitch different from the pitch of the first threaded portion, and suitable for co-operating with the tapped hole (12) of the support. The device also includes a washer (14) presenting on one side a bearing face (15) for bearing against the sensor, and on its other side, a contact face (16) for contacting the support, the washer (14) being provided with a through bore (25) for mounting the assembly element, the washer and the element being mounted together by an assembly system (30) connecting them together in rotation about the longitudinal axis, while leaving them free to move in translation.

The present invention relates to the technical field of systems or mechanisms for fastening a sensor in the general sense on a support.

More precisely, the invention relates to systems enabling a sensor to be fastened on a support that is provided with a tapped hole that is blind or difficult of access, the sensor being provided with a thread usually presented by a blind tapped hole, and the sensor being fastened with a determined orientation.

A particularly advantageous, but non-exclusive application of the invention lies in the field of mounting a sensor of the three-axis accelerometer type on a machine, when it is necessary for the measurement axes to be accurately oriented.

In the preferred field of application, it is known to mount a sensor of the three-axis accelerometer type on a machine in order to measure and characterize the vibration levels of the machine. Such a sensor needs to be mounted on the machine firstly with a determined orientation and secondly in such a manner as to guarantee high quality tightening between the sensor and the machine. For an accelerometer type sensor, proper tightening of the sensor on the machine serves to guarantee a good mechanical bandwidth for the assembly device used.

In order to comply with such technical characteristics, the prior art proposes various solutions making use of an adaptor that is in the form of a stud that includes, at one end, a first threaded portion adapted to co-operate with a blind tapped hole of the sensor, and at its opposite end, a second threaded portion for co-operating with the tapped hole provided in the machine.

In order to enable the sensor to be positioned with the correct orientation when it is fastened using a stud, it is known to interpose spacers between the base of the sensor and the machine. In addition to the fact that the operation of positioning the sensor is then not simple to carry out, the presence of spacers degrades the quality of the interface obtained between the sensor and the machine.

In order to avoid using spacers, it is known to screw the second portion of the stud not directly into the machine, but into an adaptor part that is fastened on the machine, e.g. by adhesive or by magnetism. Although that solution makes it easy to position the sensor, it does not make it possible to guarantee the best possible quality for the assembly and for the interface between the sensor and the machine.

U.S. Pat. No. 6,435,902 describes a device for assembling a sensor on a machine by means of a stud having a first threaded portion for co-operating with a hole formed in the machine. The stud also has a second threaded portion for co-operating with the tapping in a nut that is mounted to rotate freely relative to the base of the sensor. Although that solution makes it easy to orient the sensor and guarantees good contact between the sensor and the machine, such a device can be used only for sensors that are fitted with a tapped nut that is mounted with freedom to rotate. In other words, that solution cannot be used with sensors that are available on the market but that do not include a tapped nut mounted in their base with freedom to move in rotation.

Document DE 10 2004 046559 describes a device for assembling a sensor with a support that has a tapped hole. That device includes an assembly element that includes, starting from one end, a first threaded portion adapted to co-operate with a mounting nut of the sensor. That assembly element includes from its opposite end, a second threaded portion co-operating with the tapped hole in the support and bordered by a flange for coming to bear against the support while the second threaded portion is being screw-tightened. That document does not provide any solution for positioning the sensor with a determined orientation and with a controlled tightening force.

The present invention seeks to remedy the drawbacks of the prior art technical solutions by proposing a device making it easy to assemble a sensor of universal nature at a determined orientation relative to a support, the sensor being provided with a thread, and the assembly device guaranteeing rigid and effective assembly between the sensor and the support.

Another object of the invention is to provide an assembly device between a sensor and a support suitable for guaranteeing an interface with high quality contact between the sensor and its support, in particular in terms of the mechanical bandwidth through the assembly device.

To achieve such an object, the invention relates to a device for assembling together at a determined orientation both a sensor provided with a thread and a support having a tapped hole, the device comprising an assembly element presenting a longitudinal axis and including firstly, at one end, a first threaded portion adapted to co-operate with the thread of the sensor, and secondly, at its opposite end, a second threaded portion adapted to co-operate with the tapped hole of the support, the first and second threaded portions possessing thread pitches such that the ratio of the pitch of the second portion over the pitch of the first portion is not equal to 1. According to the invention, the assembly device includes a washer presenting on one side a bearing face for bearing against the sensor, and on its other side, a contact face for contacting the support, the washer being provided with a through bore for mounting the assembly element so that the first threaded portion is accessible from the bearing face and the second threaded portion projects from the contact face, the washer and the assembly element being arranged to include between them an assembly system serving firstly to provide connection in rotation about the longitudinal axis between the assembly element and the washer, and secondly freedom to move in translation along the longitudinal axis between the assembly element and the washer, the washer including grip means suitable, when the washer lies between the sensor and the support, firstly for enabling the washer to be held stationary while the sensor is being turned relative to the washer, and secondly to enable the washer to be turned with its contact face in contact with the support while the sensor is held stationary.

The device of the invention also includes in combination any one and/or another of the following additional characteristics:
the assembly system between the washer and the assembly element comprises a male member provided on the washer or on the assembly element, and a complementary female member provided respectively in the assembly element or in the washer;
the male and female members are arranged between a zone of the bore in the washer and an intermediate zone of the assembly element situated between the first and second threaded portions;
as grip means, the washer includes means enabling it to be turned;
a table expressing conversion ratios between firstly the offset angle between the orientation occupied by the sensor in the final tightened state and the orientation desired for the sensor, and secondly the angle through which the washer is to be turned relative to the sensor while the sensor is held stationary;
the washer includes an abutment limiting movement in translation of the first threaded portion projecting relative to the bearing face of the washer;
the washer includes a shoulder of diameter smaller than the diameter of the washer, and defining the contact face for contacting the support; and
the thread of the sensor is presented by a blind tapped hole or by a threaded peg co-operating with the first threaded portion of the assembly element as presented respectively by a screw or by a blind tapped hole.

Another object of the invention is to provide a method that is simple and quick for orienting a sensor provided with a thread that is difficult of access relative to a support in the general sense.

The method of the invention seeks to assemble together at a determined orientation both a sensor provided with a thread and a support having a tapped hole, the method comprising the following steps:
mounting the sensor on the support using an assembly device including a washer having an assembly element of longitudinal axis passing therethrough, the assembly element presenting firstly a first threaded portion projecting from a bearing face of the washer and screwed to the thread of the sensor, and secondly a second threaded portion projecting from a contact face of the washer and screwed in the tapped hole of the support, the washer and the assembly element being constrained together in rotation about the longitudinal axis by an assembly system, and being free to move relative to each other in translation along the longitudinal axis;
ensuring that the sensor is screw-tightened in a predetermined tightening state with the faces of the washer being in contact respectively with the sensor and with the support;
determining the angular offset between the orientation occupied by the sensor and the orientation desired for the sensor;
loosening the sensor while holding the washer stationary;
causing the washer and the sensor to turn relative to each other by turning the washer or the sensor while holding stationary respectively the sensor or the washer, through an angle for positioning the sensor with its desired orientation; and
providing relative tightening between the sensor and the washer by causing the washer or the sensor to turn while holding stationary respectively the sensor or the washer, until the sensor occupies its final assembled position.

The assembly method of the invention also includes in combination any one and/or another of the following additional characteristics:
causing the washer and the sensor to turn relative to each other while holding the sensor stationary and turning the washer through an angle corresponding to the orientation angular offset multiplied by a factor depending on the ratio between the pitches of the threaded portions of the assembly element, and then holding the washer stationary while screwing the sensor to its final tightened state;
causing the washer and the sensor to turn relative to each other while holding the washer stationary and loosening the sensor until it occupies the desired orientation, and then holding the sensor stationary at said orientation while screwing the washer until reaching the final tightened state of the sensor;
turning the washer in a direction that depends on the ratio between the pitches of the threaded portions;
turning the washer through an angle corresponding to the orientation angular offset multiplied by a factor equal to 1/(1−R), where R is equal to the ratio of the pitch of the second threaded portion over the pitch of the first threaded portion;
in order to mount the sensor on the support, screwing the second threaded portion of the assembly element into the tapped hole of the support and mounting the washer on the assembly element until the contact face comes to bear flat against the support, with the first threaded portion of the assembly element being accessible from the bearing face of the washer in order to enable the sensor to be screwed thereto; and
for mounting the sensor on the support, firstly mounting the assembly element in the washer so that the first threaded portion is accessible from the first face of the washer so as to enable the thread of the sensor to be screwed to the first threaded portion, and then screwing the second threaded portion of the assembly element into the tapped hole of the support until the contact face of the washer comes to bear against the support.

The invention also provides equipment including a sensor assembled with a determined orientation on a support by using a device in accordance with the invention.

Various other characteristics appear from the following description given with reference to the accompanying drawings, which show embodiments of the invention as non-limiting examples.

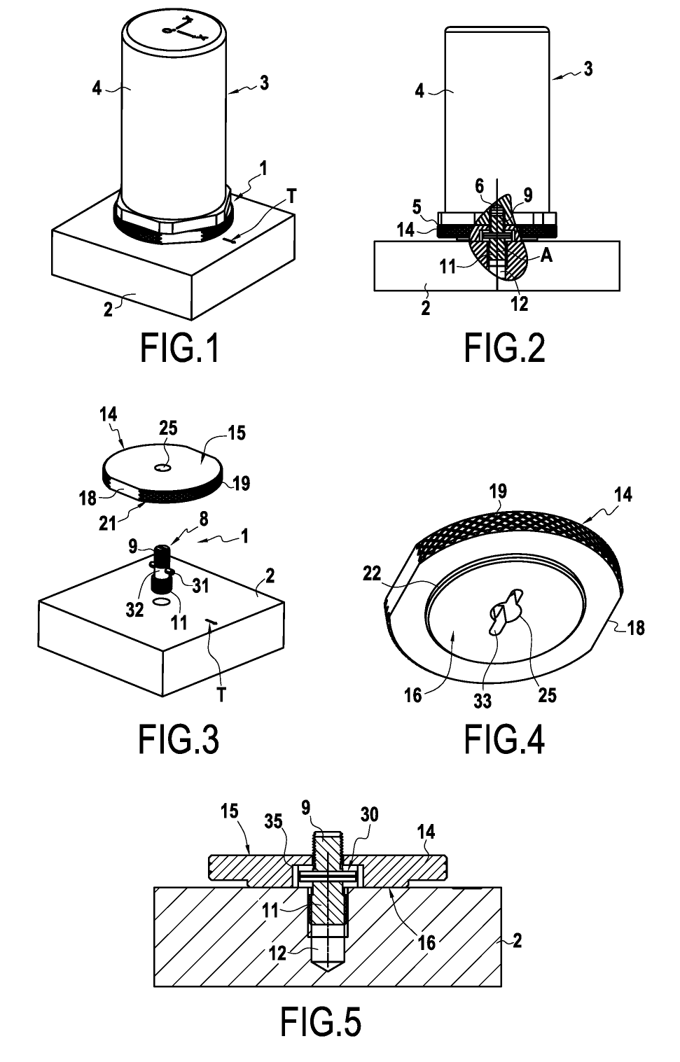

FIG. 1 is a perspective view of a sensor assembled on a support using an assembly device in accordance with the invention.

FIG. 2 is an elevation view partially in section showing a sensor of the type presenting a tapped fastener hole and mounted on the support using an assembly device in accordance with the invention.

FIG. 3 is a perspective view seen from above of the assembly device in association with a support.

FIG. 4 is a view from beneath of the washer forming part of the assembly device in accordance with the invention.

FIG. 5 is an elevation view in section showing the assembly device mounted on a support.

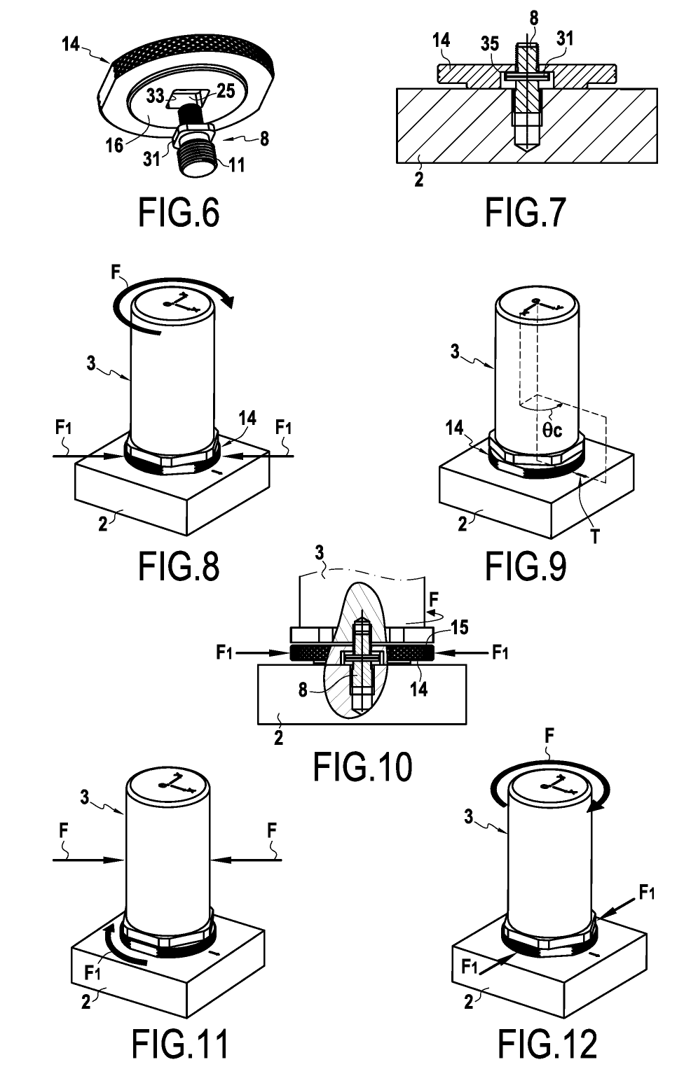

FIG. 6 is a perspective view showing another example of the assembly between the washer and the stud forming part of the assembly device in accordance with the invention.

FIG. 7 is an elevation view in section showing the stud mounted in abutment inside the washer.

FIGS. 8 to 12 are views showing the various steps in a first mounting procedure for mounting the sensor on a support that is already fitted with the assembly device in accordance with the invention.

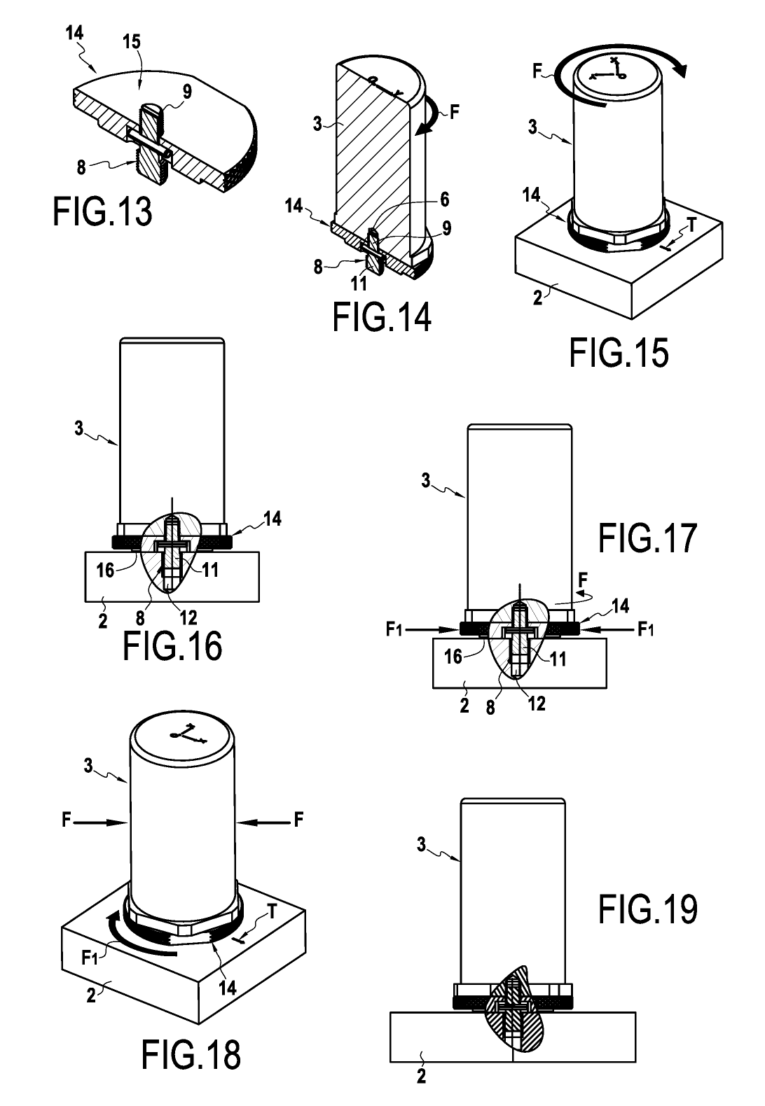

FIGS. 13 and 14 are views showing a second mounting procedure describing the steps of mounting the assembly device in accordance with the invention on the sensor.

FIGS. 15 to 19 are views showing the second mounting procedure describing the steps of mounting the sensor fitted with the assembly device in accordance with the invention on a support.

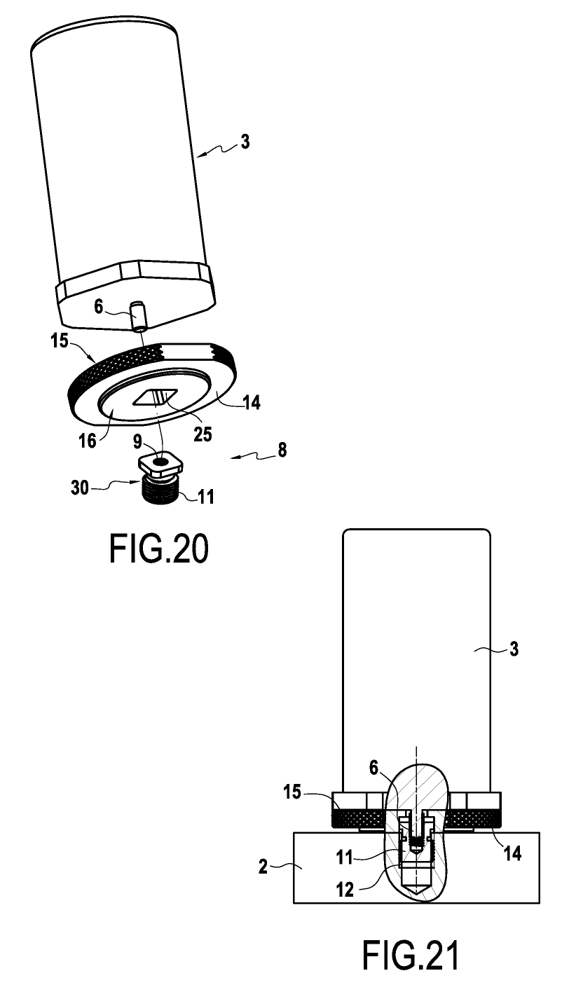

FIG. 20 is a perspective view of a sensor of the type presenting a threaded fastener peg for assembling by using an assembly device in accordance with the invention.

FIG. 21 is an elevation view in section showing the sensor of the type presenting a threaded fastener peg mounted on a support by using an assembly device in accordance with the invention.

As can be seen more clearly from FIGS. 1 to 6, the invention provides a device 1 for assembling a sensor 3 in the general sense on a support 2. As can be seen in FIG. 1, in the final assembled position, the sensor 1 needs to be oriented relative to the support 2 in such a manner that its axis Oₓ, shown diagrammatically on its body 4, is in alignment with the direction shown diagrammatically by the dash T marked on the support 2. In this final assembled position, the sensor 3 is also in a final tightened state in which the sensor 3 is assembled on the support 2 with the recommended tightening torque.

The sensor 3 comprises a general body 4 presenting a bearing face 5. The sensor 3 has a thread 6 for mounting it on the support 2 by using the assembly device 1 in accordance with the invention. In the variant embodiment shown in FIGS. 1 to 19, the thread 6 of the sensor is presented by a blind tapped hole 6 formed in the bearing face 5 so that the sensor 3 is of the type having a tapped fastener hole. In the description below, the thread 6 is referred to as the blind tapped hole 6. In another variant embodiment, shown in FIGS. 20 and 21, the thread 6 is presented by a threaded peg, which thus projects from the bearing face 5. In this variant shown in FIGS. 20 and 21, the sensor 3 is of the threaded fastener peg type.

The sensor 3 may be of any suitable kind. In a preferred embodiment, the sensor 3 is a three-axis accelerometer. In this application, the support 2 is a machine having vibratory characteristics that are to be analyzed. In another possible application, the sensor 3 may be a camera suitable for being fastened on and oriented relative to the support 2.

The assembly device 1 of the invention includes an assembly element 8 such as a stud extending along a longitudinal axis A. The stud 8 includes, starting from one end, a first threaded portion 9 for co-operating with the thread 6 of the sensor 3. In the example shown in FIGS. 1 to 19, the first threaded portion 9 of the assembly element 8 is of the male type such as a threaded fastener peg, suitable for co-operating with the blind tapped hole 6 of the sensor 3. This first threaded portion 9 has a thread of nominal diameter N_{c} and of pitch P_{c}. It should be observed that when the thread 6 of the sensor is presented by a threaded peg, then the first threaded portion 9 of the assembly element 8 is of the female type such as a blind tapped fastener hole (FIGS. 20 and 21).

Starting from its end opposite to the end provided with the first threaded portion 9, the stud 8 has a second threaded portion 11 suitable for co-operating with a tapped hole 12 formed in the support 2. A particularly advantageous application of the invention lies with the tapped hole 12 of the support 2 being a hole that is blind or difficult of access.

The second threaded portion 11 of the stud 8 has a thread of nominal diameter Nₛ and of pitch Pₛ. According to a characteristic of the invention, the first and second threaded portions 9 and 11 possess thread pitches such that the ratio R of the pitch Pₛ of the second portion over the pitch P_{c} of the first portion 9 is not equal to 1. In a preferred variant embodiment, the ratio R is strictly greater than 1. In the description below, the pitches of the first and second threaded portions 9 and 11 of the stud are considered to be handed in the same direction so that they are tightened clockwise. Naturally, in another embodiment, the pitches of the first and second threaded portions 9 and 11 could be oppositely handed.

The assembly device 1 of the invention also includes a washer 14 presenting on one side a “bearing” first face 15 for bearing against the bearing face 5 of the sensor 3, and on the other side, a “contact” second face 16 for making contact with the support 2. The first and second faces 15 and 16 extend in mutually parallel planes.

The washer 14 is advantageously grippable in order to be capable of being turned or held stationary, as explained in greater detail in the description below. For this purpose, the washer 14 is arranged to present manual or mechanical type grip means. The grip means of the washer 14 enable the washer to be turned. For example, as grip means, the washer 14 may include flats 18 and/or knurling 19 arranged on the edge face 21 of the washer 14. The washer 14 thus presents an edge face of sufficient size to enable flats to be made that are suitable for co-operating with a driver tool such as a wrench. Likewise, the knurling 19 provided on the edge of the washer is suitable for enabling it to be gripped manually by an operator.

According to a characteristic of the invention, the washer 14 is provided with a through bore 25 opening out into both of its first and second faces 15 and 16. The bore 25 presents a diameter enabling it to receive the stud 8. Thus, the stud 8 may be inserted inside the bore 25 so that the first threaded portion 9 can project from the first face 15, while the second threaded portion 11 can project from the second face 16. In this way, and as can be seen more clearly in FIGS. 2 and 5, the first threaded portion 9 of the stud 8 that projects from the bearing face 15 can be screwed into the blind hole 6 of the sensor 3, while the second threaded portion 11 of the stud 8 that projects from the contact face 16 can be screwed into the tapped hole 12 of the support 2. As explained in greater detail below in the description, the stud 8 thus serves to assemble together the sensor 3 and the support 2, with the washer 14 between them having its first and second faces 15 and 16 in contact respectively with the sensor 3 and with the support 2.

In the example shown in FIGS. 1 to 19, the first threaded portion 9 of the stud 8 is accessible from the first face 15 of the washer 14 in order to be screwed into the blind tapped hole 6 of the sensor. When the sensor 3 is of the type having a threaded fastener peg (FIGS. 20-21), the first threaded portion 9 of the stud 8, which is a blind tapped hole, is accessible from the first face 15 of the washer 14 to enable the threaded peg of the sensor to be screwed into it. This first threaded portion 9 projects from the first face 15 of the washer 14, or as shown in FIG. 21, it is set back therefrom.

According to a characteristic of the invention, the washer 14 and the stud 8 are mounted together using an assembly system 30 ensuring they are constrained to turn together about the longitudinal axis A of the stud, while allowing them to move in translation along the longitudinal axis A. The washer 14 and the stud 8 are arranged so as to include an assembly system 30 serving firstly to connect together the washer 14 and the stud 8 in rotation about the longitudinal axis A, and secondly so as to allow the washer 14 and the stud 8 to move freely in translation along the longitudinal axis A. Thus, the assembly system 30 constitutes a sliding connection serving firstly to ensure that a turning force applied to the washer 14 drives corresponding turning of the stud 8, and secondly allowing the stud 8 to move in translation relative to the washer 14 along the longitudinal axis A.

This assembly system 30 may be made in any appropriate manner. For example, the assembly system 30 may comprise a male element 31 extending radially through the stud 8 in an intermediate zone 32 of the stud that is situated between the first and second threaded portions 9 and 11.

The male element 31 serves to co-operate with a female member 33 of complementary shape arranged in the washer 14. This female member 33 is arranged in a zone of the bore 25 in the washer to have a profile and a section that are complementary to the male element 31, ignoring clearance.

In the example shown in FIGS. 2 to 5, the male element 31 is constituted by a pin extending radially through the stud, whereas in the embodiment shown in FIGS. 6 and 20, the male element 31 is of prismatic shape extending around the entire periphery of the stud in the intermediate zone 32. In the embodiment shown in FIGS. 2 to 5, the female member 33 is formed by an open slot arranged on either side of the bore 25, whereas in the embodiment shown in FIGS. 6 and 20, the female member 33 is formed by a prismatic housing arranged to communicate with the housing 25. The female member 33 and the male member 31 present prismatic shapes that are complementary so as to provide a connection in turning between the stud 8 and the washer 14. The slot or the housing 33 is arranged over a determined height so as to allow relative movement in translation between the stud 8 and the washer 14 along a direction parallel to the longitudinal axis A of the stud. The washer 14 and the stud 8 are assembled together by a sliding connection.

In a preferred embodiment, the washer 14 includes an abutment 35 limiting the movement in translation of the first threaded portion 9 projecting from the first face 15 of the washer 14. It should be understood that this abutment limits the extent to which the threaded portion can be extended from the first face 15, thereby limiting the extent to which the stud can be engaged in the blind tapped hole 6 of the sensor. The abutment 35 thus serves to avoid damaging the sensor by tightening the stud excessively inside the sensor 3.

In the example shown in the drawings, the abutment 35 is provided by the bottom of the slot, i.e. the female member 33. The female member is arranged starting from the second face 16 of the washer 14 to extend over a determined depth that allows the stud to slide freely relative to the washer.

In a preferred embodiment as shown in FIG. 4, the washer 14 has a step or shoulder 22 defining the contact face 16 that comes into contact with the support 2. The contact face 16 presents a diameter that is smaller than the diameter of the washer 14. As can be seen more clearly in FIG. 4, the contact face 16 is set back relative to the side face 21 of the washer. This configuration is particularly advantageous to enable the sensor to be fitted onto a support 2 that is not plane. Under such circumstances, the tapped hole 12 is arranged at the center of a spot face made on the support 2 and adapted to define a housing for receiving the step 22. Naturally, the depth of the spot face is less than the height of the step 22 so as to ensure effective contact between the support 2 and the contact face 16 of the washer 14.

The assembly device 1 of the invention makes it easy to mount the sensor 3 with a determined orientation on a support 2 using either of two procedures, each essentially comprising two stages, namely an assembly stage proper in which the sensor is assembled on the support, and a stage of adjusting the orientation of the sensor on the support in order to obtain the final assembled position with the recommended tightening torque.

The first procedure consists in fitting the support 2 with the stud 8 and the washer 14 prior to mounting the sensor, while the second procedure consists in fitting the sensor 3 with the stud 8 and the washer 14 prior to mounting it on the support 2.

The first procedure consists in fitting the support 2 with the stud 8 and the washer 14. Thus, and as can be seen more clearly in FIGS. 3 and 5, the second threaded portion 11 of the stud 8 is screwed into the support 2 and the washer 14 is placed on the stud 8 by causing the first threaded portion 9 of the stud to pass through the through bore 25 of the washer. The washer 14 is positioned in such a manner that its contact face 16 comes to bear flat against the support 2.

It should be observed that when the washer 14 includes an abutment 35, the washer 14 may be turned in order to turn the stud 8 so as to screw it into the support 2 so as to cause the contact face 16 of the washer to bear against the support 2. Furthermore, as shown in FIG. 7, the male member 31 may be in contact with the abutment 35. This abutment position shown in FIG. 7 corresponds to the position of maximum extension for the first threaded portion 9 relative to the first face 15 of the washer. This abutment position thus prevents any possibility of adjusting in particular the tightening of the washer, as explained in the description below. To make all adjustment possibilities available during the stage of adjusting orientation, the washer 14 is turned so as to position the stud 8 in an intermediate position (shown in FIG. 5) between these positions of contact between its male member 31 and the abutment 35 for the support 2.

The mounting method then consists in putting the sensor 3 into place on the support 2 that has already been fitted with the stud 8 and the washer 14. For this purpose, the sensor 3 is moved towards the support 2 in order to cause the first threaded portion 9 of the stud to co-operate with the blind tapped fastener hole 6 (or the threaded fastener peg 6) of the sensor 3. While the sensor 3 is being screwed onto the stud 8 (arrow F in FIG. 8) the washer 14 is held stationary with its second face 16 in contact with the support 2 (arrow F1 in FIG. 8). The sensor 3 is thus screwed into a predetermined tightening state corresponding to the final tightened state, i.e. the state in which the sensor 3 is assembled on the support 2 with the recommended tightening torque.

In the position shown in FIG. 2, the sensor 3 is mounted on the support using the assembly device 1 in accordance with the invention in such a manner that the first threaded portion 9 of the stud 8 is screwed into the blind tapped hole 6 (or onto the threaded peg 6) of the sensor 3, while the second threaded portion 11 is screwed in the tapped hole 12 of the support 2. In this mounting position, the washer 14 lies between the sensor 3 and the support 2, with the support 2 being in contact with the contact face 16 of the washer and with the sensor 3 in contact with the bearing face 15 in a predetermined tightening state corresponding to the final mounted state.

Nevertheless, the sensor 3, which is mounted on the support 2, does not necessarily have the right orientation, so it may be necessary to perform a stage of adjusting the orientation of the sensor relative to the support 2.

This stage of adjusting the orientation of the sensor 3 consists in determining the angular offset θ_{c} between the orientation occupied by the sensor 3 and the orientation desired for the sensor 3. As can be seen more clearly in FIG. 9, the sensor 3 possesses an orientation Oₓ that needs to be placed in the direction shown diagrammatically by the dash T on the support 2. In the example shown in FIG. 9, the sensor 3 is angularly offset by an angle θ_{c} relative to the desired direction T. The stage of adjusting the orientation of the sensor 3 consists in positioning the sensor so that its orientation Oₓ is in alignment with the desired direction T.

For this purpose, the method consists in loosening and then partially unscrewing the sensor 3 while holding the washer 14 stationary (FIG. 10). For a traditional thread having a right-handed pitch P_{c}, the sensor 3 is unscrewed in a counterclockwise direction F, thereby separating the sensor from the bearing face 15 of the washer 14. It should be observed that the angular offset θ_{c} that is to be compensated can only be in the direction corresponding to unscrewing the sensor 3.

As can be seen more clearly in FIG. 11, the method then consists in preventing the sensor 3 from turning (arrows F), and in turning the washer 14 (arrow F1) through an angle of value θ_{R} enabling the sensor 3 to be positioned in its desired orientation. In the example shown, the washer 14 is turned through an angle θ_{R}, which corresponds to the offset orientation θ_{c} multiplied by a factor depending on the ratio between the pitches of the threaded portions 9 and 11 of the stud. This factor is equal to 1/(1−R) where R is equal to the ratio of the pitch Pₛ of the second threaded portion 11 over the pitch P_{c} of the first threaded portion 9. In this example, it is considered that the value of a pitch Pₛ or P_{c} is positive if the pitch of the thread is right-handed, and negative if it is left-handed.

If necessary, this adjustment stage may be performed several times over in succession in order to reach an accurate final adjustment.

According to an advantageous characteristic of the invention, a table is established expressing conversion ratios between firstly the value of the offset angle between the orientation occupied by the sensor in the final tightened state and the orientation desired for the sensor, and secondly the angle θ_{R} through which the washer 14 should be turned relative to the sensor while it is held stationary.

Thus, as a function of the turning angle needed to bring the sensor into the correct orientation, it is possible to know the value of the angle through which the washer needs to be turned on the basis of knowledge concerning the pitches of the threaded portions 9 and 11 of the stud 8. For example, if the pitches of the first and second threaded portions 9 and 11 are respectively 1 millimeter (mm) and 1.25 mm, then the ratio of the pitch of the second threaded portion 11 over the pitch of the first threaded portion 9 is equal to 1.25. Thus, the turning angle θ_{R} for the washer 14 is equal to θ_{c}×1/(1−R), i.e. is equal to −4×θ_{c}. In this example, if the orientation of said angle θ_{c} is equal to 15°, then the washer needs to be turned through −60°, i.e. 60° in the direction opposite to the direction in which the sensor is turned. In similar manner, if the angle θ_{c} is equal to 60°, then the washer needs to be turned through −240°, i.e. 240° in the direction opposite to the direction in which the sensor is turned. As explained above, the washer 14 is turned in a direction that depends on the ratio between the pitches of the threaded portions 9 and 11.

A table giving the conversion ratios can thus be defined for each type of stud 8 presenting pitches taken from a given range in order to make it possible to match the various pitches of the tapped holes 6 and 12 of the sensor and of the support.

The method consists in turning the washer 14 in a direction opposite to the direction in which the sensor needs to be oriented in order to occupy the correct orientation. After the washer 14 has been turned through the corresponding angle, the washer 14 is held stationary in position (arrows F1 in FIG. 12), while the sensor 3 is tightened until the sensor occupies its final tightened state. The sensor 3 thus comes back into contact with the bearing face 15 with the recommended tightening torque, while also being correctly oriented relative to the support 2.

FIGS. 13 to 19 show the other procedure for mounting the sensor 3 on the support 2. This procedure seeks to fit the sensor 3 with the stud 8 and the washer 14. This procedure presents the advantage of making it possible to assemble the sensor with the stud 8 and the washer 14 beforehand in a workshop.

The method thus consists in mounting the stud 8 in the washer 14 so as to enable the first threaded portion 9 to project from the first face 15 of the washer 14 (FIG. 13). The sensor 3, which presents a tapped fastener hole, is screwed onto the stud 8 by turning (arrow F, FIG. 14) the sensor 3 and the stud 8 relative to each other. For a sensor 3 presenting a threaded fastener peg (FIGS. 20, 21), the stud 8 is mounted in the washer 14 so that the first threaded portion 9 is accessible from the first face 15 of the washer 14 in such a manner that the threaded fastener peg 6 of the sensor can be screwed into the first threaded portion 9 of the stud.

In a preferred embodiment, tightening is continued until the abutment position, i.e. until the male member 31 comes into contact with the abutment 35 (FIG. 16).

The method then consists in putting the sensor 3 fitted with the stud 8 and the washer 14 into place on the support 2. It should be observed that in the mounted position, the second threaded portion 11 projects from the washer 14 that is fastened on the sensor (FIG. 14).

As can be seen more clearly in FIG. 15, the assembly comprising the sensor 3, the stud 8, and the washer 14 is screwed onto the support 2 by the second threaded portion 11 co-operating with the tapped hole 12 of the support 2. This assembly is tightened (arrow F, FIG. 15) until the contact face 16 of the washer 14 comes to bear against the support 2 (FIG. 16). In this position, the sensor 3 is in a predetermined tightening state that does not necessarily correspond to the final tightened state. This predetermined tightening state is such that the washer 14 bears against the support 2 and the sensor 3.

In this position, as shown in FIG. 16, the sensor 3 is mounted on the support using the assembly device 1 in accordance with the invention in such a manner that the first threaded portion 9 of the stud 8 is screwed into the blind tapped fastener hole 6 (or onto the threaded fastener peg 6) of the sensor 3, while the second threaded portion 11 is screwed into the tapped hole 12 of the support 2. In this mounting position, the washer 14 lies between the sensor 3 and the support 2, with the sensor 3 being in contact with the bearing face in a predetermined tightening state and with the support 2 being in contact with the contact face 16 of the washer. Nevertheless, the sensor 3 is not necessarily positioned in its correct orientation so the stage of adjusting the orientation of the sensor may optionally be performed.

This stage of adjusting the orientation of the sensor consists in determining the angular offset between the orientation occupied by the sensor 3 and the orientation desired for the sensor 3. By way of example, it is assumed that the sensor 3 is angularly offset by an angle θ_{c} relative to the desired direction T (FIG. 9).

The method consists in loosening the sensor 3, while holding the washer 14 stationary against turning. Thus, as shown in FIG. 17, the washer 14 is stationary (arrows F1) while the sensor 3 is turned (arrow F) in order to position the sensor in its desired orientation. This operation leads to the sensor becoming separated from the bearing face 15 of the washer. The sensor 3 is turned so that its orientation Oₓ is positioned in the direction of the dash T shown diagrammatically on the support 2 (FIG. 18). Once the sensor 3 is correctly oriented relative to the support 2, then the sensor 3 is held stationary (arrows F, FIG. 18), while the washer is turned (arrow F1) in order to obtain the final tightened state, i.e. the state in which the sensor 3 is assembled to the support 2 with the recommended tightening torque. Tightening the washer thus enables the bearing surface 15 to be put back into contact with the sensor 3 which is also correctly oriented. It should be observed that the angle through which the washer should be turned is equal to the angle through which the sensor needed to be turned in order to be oriented in the desired direction multiplied by a factor equal to 1/(1−R), plus the extra angle needed to provide the correct tightening torque.

The assembly device of the invention thus makes it easy to assemble a universal sensor provided with a blind tapped hole so that it has a determined orientation relative to a support. The assembly device of the invention guarantees rigid and effective assembly between the sensor and the support. The sensor 3 fastened on a support 2 using the assembly device 1 together form equipment that can be used in various technical fields.

The invention is not limited to the embodiments described and shown, since various modifications can be made thereto without going beyond its ambit.

1. A device for assembling together at a determined orientation both a sensor (3) provided with a thread (6) and a support (2) having a tapped hole (12), the device comprising an assembly element (8) presenting a longitudinal axis (A) and including firstly, at one end, a first threaded portion (9) adapted to co-operate with the thread (6) of the sensor, and secondly, at its opposite end, a second threaded portion (11) adapted to co-operate with the tapped hole (12) of the support, the first and second threaded portions (9, 11) possessing thread pitches such that the ratio of the pitch of the second portion over the pitch of the first portion is not equal to 1, the device being characterized in that it includes a washer (14) presenting on one side a bearing face (15) for bearing against the sensor, and on its other side, a contact face (16) for contacting the support, the washer (14) being provided with a through bore (25) for mounting the assembly element so that the first threaded portion (9) is accessible from the bearing face (15) and the second threaded portion (11) projects from the contact face (16), the washer (14) and the assembly element (8) being arranged to include between them an assembly system (30) serving firstly to provide connection in rotation about the longitudinal axis between the assembly element (8) and the washer (14), and secondly freedom to move in translation along the longitudinal axis (A) between the assembly element (8) and the washer (14), the washer (14) including grip means suitable, when the washer lies between the sensor (3) and the support (2), firstly for enabling the washer (14) to be held stationary while the sensor is being turned relative to the washer, and secondly to enable the washer (14) to be turned with its contact face (16) in contact with the support (2) while the sensor (3) is held stationary.

2. A device according to claim 1, characterized in that the assembly system (30) between the washer (14) and the assembly element (8) comprises a male member (31) provided on the washer (14) or on the assembly element, and a complementary female member (33) provided respectively in the assembly element (8) or in the washer (14).

3. A device according to claim 2, characterized in that the male and female members (31, 33) are arranged between a zone of the bore in the washer and an intermediate zone (32) of the assembly element situated between the first and second threaded portions.

4. A device according to claim 1, characterized in that the washer (14) includes grip means, enabling the washer to be turned.

5. A device according to claim 1, characterized in that it includes at least one table expressing conversion ratios between firstly the offset angle (θ_{c}) between the orientation occupied by the sensor (3) in the final tightened state and the orientation desired for the sensor, and secondly the angle through which the washer is to be turned relative to the sensor while the sensor is held stationary.

6. A device according to claim 1, characterized in that the washer (14) includes an abutment (35) limiting movement in translation of the first threaded portion projecting relative to the bearing face of the washer.

7. A device according to claim 1, characterized in that the washer (14) includes a shoulder (22) of diameter smaller than the diameter of the washer, and defining the contact face (16) for contacting the support (2).

8. A device according to claim 1, characterized in that the thread (6) of the sensor is presented by a blind tapped hole or by a threaded peg co-operating with the first threaded portion (9) of the assembly element (8) as presented respectively by a screw or by a blind tapped hole.

9. A method of assembling together at a determined orientation both a sensor provided with a thread (6) and a support (2) having a tapped hole (12), the method being characterized in that it comprises the following steps:
mounting the sensor (3) on the support (2) using an assembly device (1) including a washer (14) having an assembly element (8) of longitudinal axis (A) passing therethrough, the assembly element presenting firstly a first threaded portion (9) projecting from a bearing face (15) of the washer and screwed to the thread (6) of the sensor, and secondly a second threaded portion (11) projecting from a contact face (16) of the washer (14) and screwed in the tapped hole (12) of the support (2), the washer (14) and the assembly element being constrained together in rotation about the longitudinal axis (A) by an assembly system (30), and being free to move relative to each other in translation along the longitudinal axis (A);
ensuring that the sensor (3) is screw-tightened in a predetermined tightening state with the faces (15, 16) of the washer being in contact respectively with the sensor (3) and with the support (2);
determining the angular offset between the orientation occupied by the sensor and the orientation desired for the sensor;
loosening the sensor (3) while holding the washer (14) stationary;
causing the washer (14) and the sensor (3) to turn relative to each other by turning the washer or the sensor while holding stationary respectively the sensor or the washer, through an angle for positioning the sensor with its desired orientation; and
providing relative tightening between the sensor (3) and the washer (14) by causing the washer or the sensor to turn while holding stationary respectively the sensor or the washer, until the sensor occupies its final assembled position.

10. A method according to claim 9, characterized in that it consists in causing the washer (14) and the sensor (3) to turn relative to each other while holding the sensor (3) stationary and turning the washer (14) through an angle corresponding to the orientation angular offset (θ_{c}) multiplied by a factor depending on the ratio between the pitches of the threaded portions of the assembly element, and in that it then consists in holding the washer (14) stationary while screwing the sensor (3) to its final tightened state.

11. A method according to claim 9, characterized in that it consists in causing the washer (14) and the sensor (3) to turn relative to each other while holding the washer stationary and loosening the sensor until it occupies the desired orientation, and in that it then consists in holding the sensor stationary at said orientation while screwing the washer until reaching the final tightened state of the sensor.

12. A method according to claim 10, characterized in that it consists in turning the washer (14) in a direction that depends on the ratio between the pitches of the threaded portions.

13. A method according to claim 10, characterized in that it consists in turning the washer (14) through an angle corresponding to the orientation angular offset multiplied by a factor equal to 1/(1−R), where R is equal to the ratio of the pitch of the second threaded portion (11) over the pitch of the first threaded portion (9).

14. A method according to claim 9, characterized in that it consists, in order to mount the sensor (3) on the support (2), in screwing the second threaded portion (11) of the assembly element (8) into the tapped hole (12) of the support (2) and in mounting the washer (14) on the assembly element (8) until the contact face (16) comes to bear flat against the support (2), with the first threaded portion (11) of the assembly element being accessible from the bearing face (15) of the washer (14) in order to enable the sensor to be screwed thereto.

15. A method according to claim 9, characterized in that it consists, for mounting the sensor (3) on the support (2), firstly in mounting the assembly element (8) in the washer (14) so that the first threaded portion (9) is accessible from the first face (15) of the washer (14) so as to enable the thread (6) of the sensor (3) to be screwed to the first threaded portion (9), and then in screwing the second threaded portion (11) of the assembly element (8) into the tapped hole (12) of the support (2) until the contact face (16) of the washer (14) comes to bear against the support (2).

16. Equipment, characterized in that it includes a sensor (3) assembled at a determined orientation on a support (2) by using a device (1) in accordance with claim 1.
